(19) United States
(12) Patent Application Publication
(10) Pub. No.: US 2016/0188130 A1
(43) Pub. Date: Jun. 30, 2016

(54) Automatic Conditional Application Downloading

(71) Applicant: Quixey, Inc., Mountain View, CA (US)

(72) Inventors: Michael Harris, Mountain View, CA (US); Eric J. Glover, Palo Alto, CA (US); Gilead Mark, Palo Alto, CA (US)

(73) Assignee: Quixey, Inc., Mountain View, CA (US)

(21) Appl. No.: 14/862,917

(22) Filed: Sep. 23, 2015

Related U.S. Application Data
(60) Provisional application No. 62/097,282, filed on Dec. 29, 2014.

(51) Int. Cl. G06F 3/0482; H04L 29/08; H04L 12/24; G06F 3/0484

(52) U.S. Cl. CPC G06F 3/0482; G06F 3/04842; G06F 3/04847; H04L 67/34; H04L 67/02; H04L 41/22

(57) ABSTRACT

A method includes receiving one or more application access mechanisms. Each application access mechanism is associated with an application executable on data processing hardware and indicates an operation to download the application to the data processing hardware. The method also includes identifying at least one application for download to the data processing hardware from the one or more application access mechanisms based on user selectable parameters. The user selectable parameters include one or more user defined rules associated with the data processing hardware and/or the identified at least one application. The method also includes downloading the identified at least one application to first allocation of non-transitory memory and deleting it after one or more conditions are satisfied or moving it to second allocation of non-transitory memory. For each identified application, the operation of the corresponding application access mechanism.

### CROSS REFERENCE TO RELATED APPLICATIONS

This U.S. patent application claims priority under 35 U.S.C. §119(e) to U.S. Provisional Application 62/097,282, filed on Dec. 29, 2014, which is hereby incorporated by reference in its entirety.

### TECHNICAL FIELD

This disclosure relates to automatic conditional application downloading.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre and each application may have numerous editions.

### SUMMARY

One aspect of the disclosure provides a method for automatic conditional application downloading. The method may be executed on a user device that includes a display in communication with data processing hardware. The user device may also include non-transitory memory in communication with the data processing hardware. The non-transitory memory stores instructions that when executed on the data processing hardware cause the data processing hardware to perform operations of a method. The method includes receiving, at the data processing hardware, one or more application access mechanisms (e.g., an application resource identifier or a string that includes a reference to a native application and/or indicated one or more operations for execution by the nation application on the user device). The method also includes identifying at least one application for download to the data processing hardware from the one or more application access mechanisms based on user selectable parameters (or permissions). Each application access mechanism is associated with an application executable on the data processing hardware and indicating an operation to download the application to the data processing hardware. The user selectable parameters include one or more user defined rules associated with the data processing hardware and/or the identified at least one application. The method further includes downloading the identified at least one application to first allocation of non-transitory memory of the data processing hardware using, for each identified application, the operation of the corresponding application access mechanism. The method also includes displaying, on a display in communication with the data processing hardware, a graphical user interface including, for each identified application, an associated user selectable link referencing the corresponding application.

Implementations of the disclosure may include one or more of the following optional features. In some implementations, the user selectable parameters or permissions include one or more of an application size, a user device connection to a network, an application category, an application developer, or an application user review. The graphical user interface may include an indication of a download progress of the identified at least one application. In some examples, the method further includes receiving, at the data processing hardware, a selection of a user selectable link and executing an application referenced by the user selectable link. Additionally or alternatively, the method may further include, when executing the application, receiving, at the data processing hardware, a permission request including an access permission to allow the application to access information on the user device, and displaying in the graphical user interface one or more user selectable permissions. The method may also include receiving, at the data processing hardware, a selection of one or more user selectable permissions. Each user selectable permission may be associated with a permission request.

In some examples, the method includes downloading the identified at least one application to the first allocation of non-transitory memory, associating a download start time with the identified at least one application. The method may further include, for each application downloaded to the first allocation of non-transitory memory, deleting the application from the first allocation of non-transitory memory after a threshold period of time after the associated download start time, or moving the application from the first allocation of non-transitory memory to second allocation of non-transitory memory in communication with the data processing hardware.

Another aspect of the disclosure provides a second method for automatic conditional application downloading. The method may be executed on a user device that includes a display in communication with data processing hardware. The user device may also include non-transitory memory in communication with the data processing hardware. The non-transitory memory stores instructions that when executed on the data processing hardware cause the data processing hardware to perform the method (or operations). The method includes receiving, at the data processing hardware, search results transmitted from a search system in communication with the data. processing hardware, and identifying, at the data processing hardware, at least one application for download to the data processing hardware from the one or more application access mechanism based on the user selectable parameters. The search results include one or more application access mechanisms; each application access mechanism is associated with an application executable on the data processing hardware and indicating an operation to download the application to the data processing hardware. The user selectable parameters include one or more user defined rules associated with the data processing hardware and/or the identified at least one application. The method further includes downloading the identified at least one application to the data processing hardware using, for each identified application, the operation of the corresponding application access mechanism.

In some examples, the user selectable parameters include one or more of an application size, a user device connection to a network, an application category, an application developer, or an application user review. The graphical user interface may include an indication of a download progress of the identified at least one application. The operations may further include receiving, at the data processing hardware, a selection of a user selectable link, and executing an application referenced by the user selectable link. Additionally or alternatively, the operations may further include, when executing the application, receiving, at the data processing hardware, a permission request including an access permission allowing the application to access information on the user device.

The method further includes displaying in the graphical user interface one or more user selectable permissions, each user selectable permission associated with a permission request and receiving, at the data processing hardware, a selection of one or more user selectable permissions.

In some examples, the method includes, when downloading the identified at least one application to the first allocation of non-transitory memory, associating a download start time with the identified at least one application. The method may further include, for each application downloaded to the first allocation of non-transitory memory, deleting the application from the first allocation of non-transitory memory after a threshold period of time after the associated download start time (or after one or more measurements are satisfied). In other examples, the method includes, for each application downloaded to the first allocation of non-transitory memory, moving the application from the first allocation of non-transitory memory to second allocation of non-transitory memory in communication with the data processing hardware.

Yet another aspect of the disclosure provides a third method for automatic conditional application downloading. The method includes receiving, at data processing hardware, user device information of a user device in communication with the data processing hardware, executing, using the data processing hardware, a search of non-transitory data store in communication with the data processing hardware using a search criteria, and receiving, at the data processing hardware, application state records from the non-transitory data store in response to the executed search. Each application state record includes an application access mechanism has a reference to a corresponding application executable on the user device and indicating an operation for downloading and installing the corresponding application on the user device and application information describing application parameters associated with the corresponding application. The method further includes identifying one or more applications based on the user device information and the application parameters for download to the user device and sending search results from the data processing hardware to the user device. The search results include an application access mechanism for each identified application.

In some implementations, the method includes receiving, at the data processing hardware, user selectable parameters. Identifying the one or more applications further includes identifying the one or more applications based on the user device information, the application parameters, and the user selectable parameters. The user selectable parameters may include one or more of an application size, a user device connection to a network, an application category, an application developer, or an application user review. Each application access mechanism of the search results may include a trigger instructing the user device to automatically download the corresponding application on the user device. The method may further include receiving, at the data processing hardware, the search criteria from the user device or determining the search criteria based on one or more application parameters.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example environment including a user device in communication with a search system and an auto-download system.

FIG. 1B is a functional block diagram of a search system interacting with user devices and data sources.

FIGS. 2A and 2B are schematic views of an example user device in communication with a search system.

FIGS. 3A and 3B are schematic views of an example user device in communication with a search system.

FIG. 4 is a schematic view of example auto-download rules for an application.

FIGS. 5A and 5B are schematic views of example application states.

FIGS. 6A and 6B are schematic views of an example user device displaying a graphical user interface that receives a search query and displays search results.

FIG. 7 is a schematic view of an example search module receiving and processing a query wrapper and outputting search results.

FIG. 8 is a schematic view of an example arrangement of operations for a method of downloading one or more identified applications on a user device.

FIG. 9 is a schematic view of an example arrangement of operations for a method of identifying one or more applications for download on a user device.

FIG. 10 is a schematic view of an example arrangement of operations for a method identifying one or more applications for download on a user device and sending the identified search results to the user device.

FIG. 11 is a schematic view of example data processing hardware executing any systems or methods described herein.

Like reference symbols in the various drawings indicate like elements.

### DETAILED DESCRIPTION

A system of the present disclosure provides a user with a list of applications that may be installed on a user device and automatically downloads one or more of the applications based on settings configured by the user. The system of the present disclosure may implement a search (executed by a search system) based on a query. In some examples, the search system receives the query from a user device that includes search criteria, generates results (e.g., search results that include real-time search results) in response to the received query, and transmits the results to the user device. The results may include various mechanisms for accessing applications (e.g., allowing the user to find a restaurant) relevant to the query of the user. In response to selection of an access mechanism, the user device may launch an application referenced in the application access mechanism and perform the one or more operations indicated in the application access mechanism. In other examples, the system implements a discovery system (not shown, but similar to the search system), where the discovery system transmits results to the user device in response to the user making one or more selections on the user device, In this case, the user device does not send a query to the discovery system. Thus, the system may be desirable to reduce the time associated with executing searches.

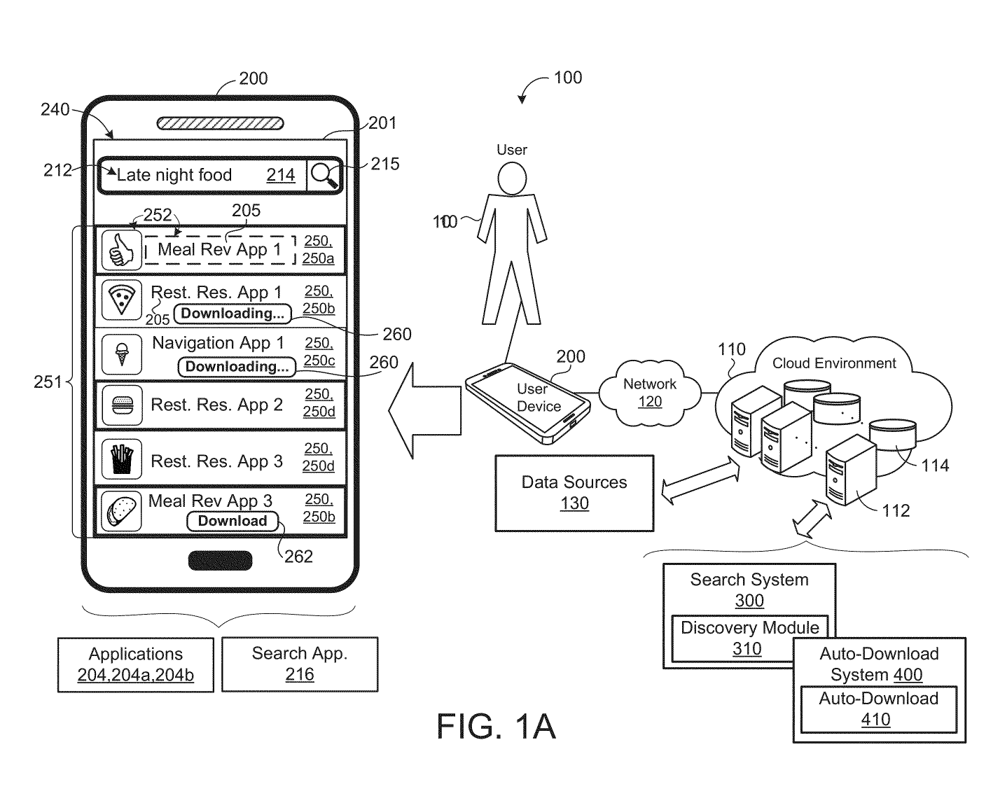

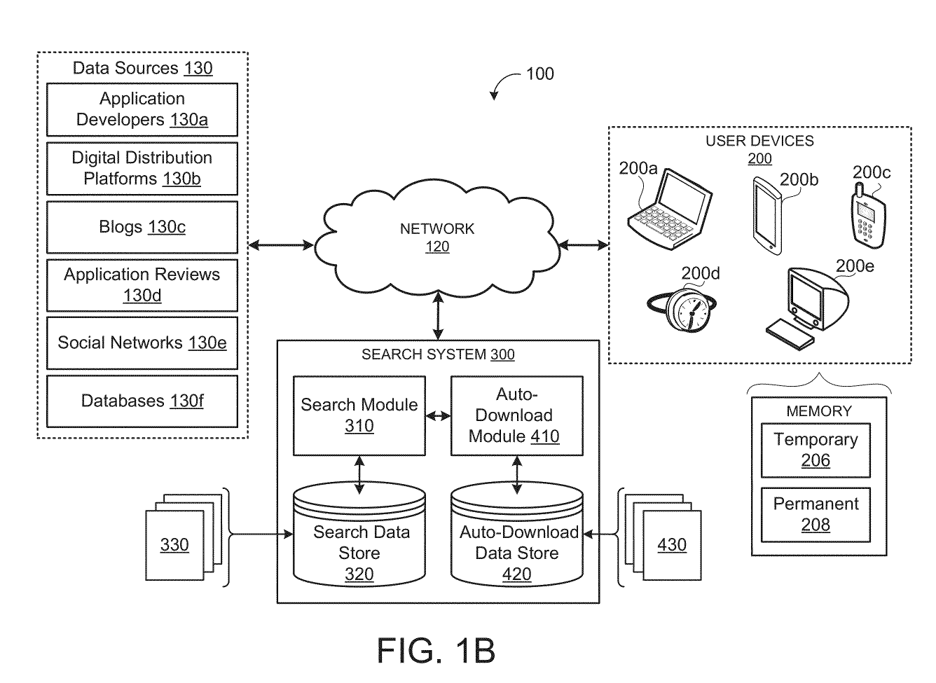

FIG. 1A illustrates an example system 100 that includes a user device 200 associated with a user 10 in communication with a remote system 110 via a network 120. FIG. 1B provides functional block diagrams of the system 100. The remote system 110 may be a distributed system (e.g., cloud environment) having scalable/elastic computing resources 112 and/or storage resources 114. The user device 200 and/or the remote system 110 may execute a search system 300 and optionally receive data from one or more data sources 130. The user device 200 and/or the remote system 110 may additionally execute an auto-download system 400. In some examples, the auto-download system 400 is part of the search system 300. In other examples, the search system 300 and the auto-download system 400 communicate with one or more user devices 200 and the data source(s) 130 via the network 120. The network 120 may include various types of networks, such as a local area network (LAN), wide area network (WAN), and/or the Internet.

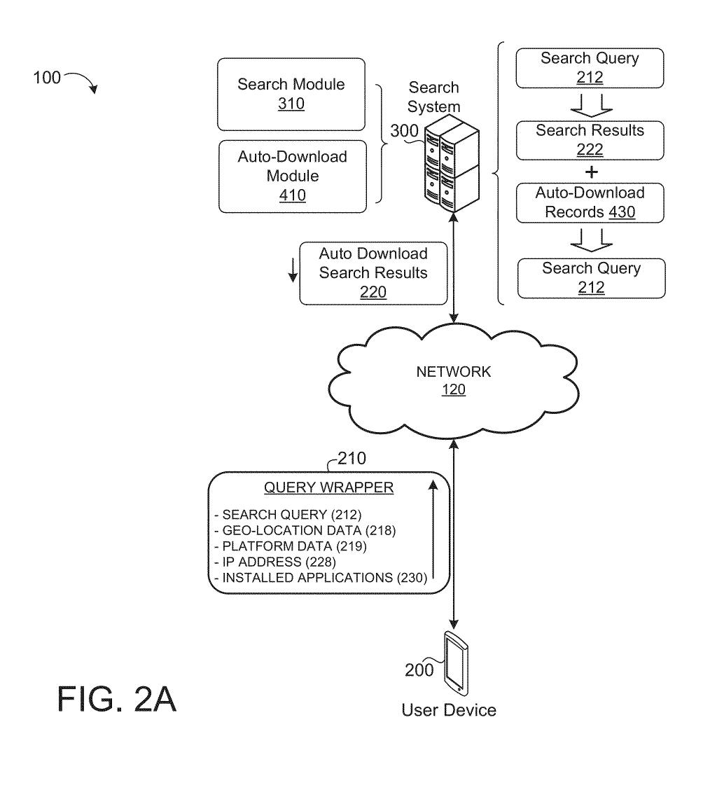

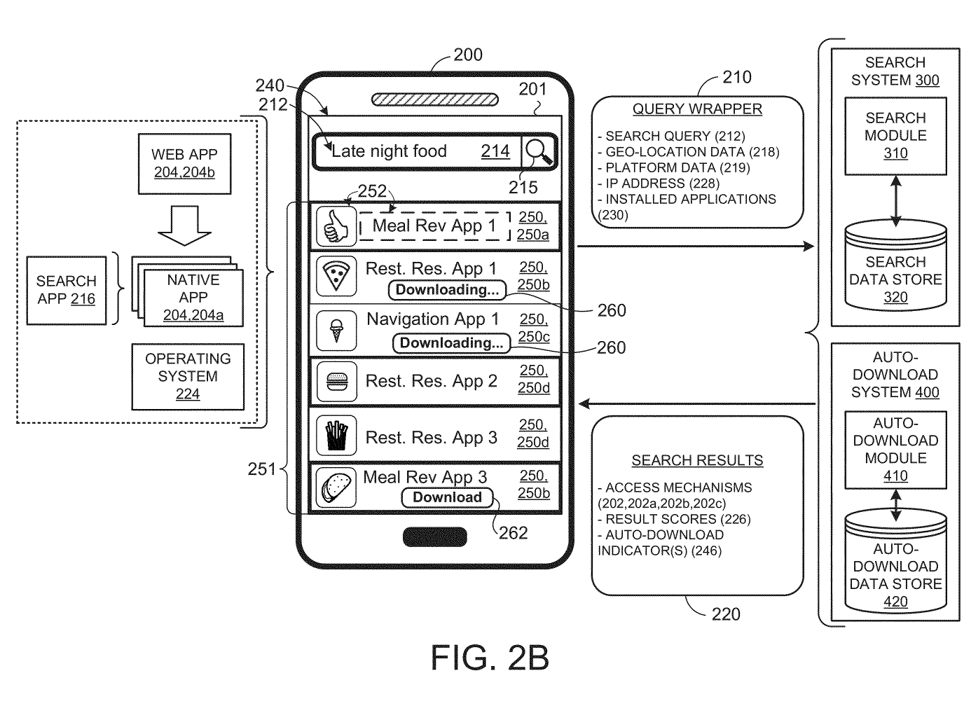

Referring to FIGS. 1A-3B, the search system 300 includes a search module 310 in communication with a search data store 320. The search data store 320 may include one or more databases, indices (e.g., inverted indices), tables, files, or other data structures, which may be used to implement the techniques of the present disclosure. The search module 310 receives a query wrapper 210 and generates search results 222 based on the data (e.g., application state records 330) included in the data store 320. In some implementations, the search module 310 receives the query wrapper 210 from the user device 200 or from a third party system in communication with the user device 200, and performs a search for application state records 330 included in the search data store 320 based on data (e.g., a search query 212) included in the query wrapper 210. Each application state record 330 includes one or more access mechanisms 202 that the user device 200 may use to access different functions for a variety of different applications, such as native applications 204a installed on the user device 200. The search system 300 also includes an auto-download module 410 in communication with an auto-download data store 420. The auto-download data store 420 includes one or more databases, indices (e.g., inverted indices), tables, files, or other data structures, which may be used to implement the techniques of the present disclosure. The auto-download module 410 receives the search results 222 from the search module 310 and generates auto-download search results 220 based on the data (e.g., auto-download records 430 (permissions)) included in the auto-download data store 420. In some examples, the search system 300 (including the search module 310 and the auto-download module 410) transmits auto-download search results 220 including a list of access mechanisms 202 to the user device 200 that generated the query wrapper 210 (see e.g. FIGS. 2A and 2B). In other examples, the search module 310 transmits the search results 222 to the user device 200 and the auto-download module 410, executing on the user device 200, and determines the auto-download results 220 based on the received search results 222.

In the examples shown, the system 100 includes a search system 300 that executes a search based on the search query 212. However, the system 100 may also be implemented using other discovery systems (not shown) that provide the user 10 with one or more applications that may be downloaded on the user device 200. For example, a user 10 may browse an application store to find one or more applications 204. In some examples, it is desirable to configure the system 100 to allow automatic downloading of one or more applications 204 from the application store to the user device 200 based on one or more conditions or parameters previously selected by the user 10. In such a case, the applications 204 are downloaded to temporary or first allocation of non-transitory memory 206 until the user 10 decides if he/she wants to delete one or more of the application(s) 204, in which case the application(s) 204 is deleted. If the user 10 decides to use one or more application(s) 204 and therefore keep it stored on non-transitory memory 206, 208 of the user device 200. The user device 200 transfers the downloaded application 204 from the temporary memory 206 to a permanent or second allocation of non-transitory memory 208.

The auto-download system 400 includes the auto-download module 410 configured to receive a user selection (in some examples, the query wrapper 210) from the user device 200 and determine, based on the user selection, one or more applications 204 that will automatically download on the user device 200. The auto-download module 410 determines the applications 204 that will be automatically downloaded to the user device 200. The auto-download module 410 transmits a list 251 of auto-download search results 220 to the user device 200. The list 251 includes application(s) 204 for downloading and a download signal (displaying a download status 260, 262) triggering the user device 200 to automatically download the corresponding application 204.

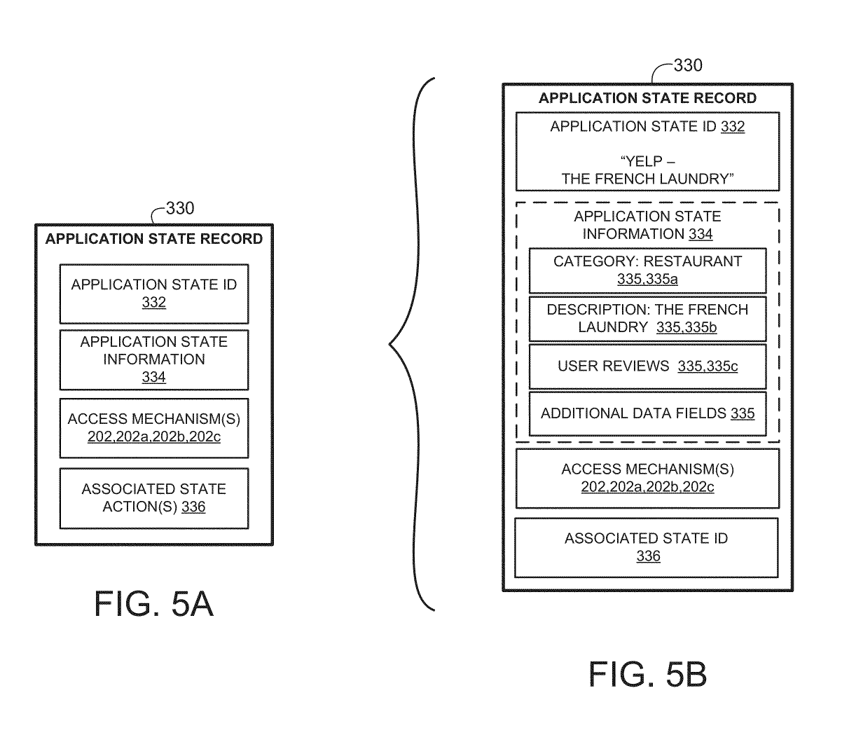

The user selection may be a selection of a category 335a (FIGS. 5A and 5B) or any other grouping of applications 204. For example, a graphical user interface (GUI) 240 of a search application 216 of the user device 200 may display one or more categories 335a or any other grouping of applications 204 and the user 10 may select, using a touchscreen keypad, a mechanical keypad, a speech-to-text program, or other form of user input, one of the displayed categories 335a or groupings. When the user 10 makes a selection, the system 100 displays a list 251 of applications e.g., links 250) that include one or more applications 204 that automatically download to the user device 200 (to a temporary non-transitory memory 206). In other examples, the user selection may be a search query 212, which may include text, numbers, and/or symbols (e.g., punctuation) entered into the user device 200 b the user 10. For example, the user 10 may enter a search query 212 into a search field 214 (e.g., a search box) of the GUI 240 of the search application 216. The user 10 may enter a search query 212 using a touchscreen keypad, a mechanical keypad, a speech-to-text program, or other forms of user input. In yet another example, the user 10 inputs the search query 212 via voice commands in the search field 214. The search query 212 may be an implicit input, for example, the user 10 may select a user-selectable link or an icon displayed on the GUI 240 that triggers a search to be executed. In some examples, an intermediate system (not shown) receives the search query 212 and modifies the search query 212 before sending the search query 212 to the search system 300. The intermediate system modifies the search query 212 to help the search system 212 execute the search. In general, a user selection may be a request for information retrieval from the search system 300 (including the auto-download system 400). For example, a user selection may be directed to retrieving a list 251 of one or more displayed application names 205, where each application name 205 is associated with a download indicator or status 260, 262 of the download status of the application 204. In addition, each application name 2.05 may include a link 250 to execute the application 204 when the download is complete (i.e., the application is downloaded to the temporary non-transitory memory 206) on the user device 200. In some examples, the user 10 selects a search button 215 after entering the search query 212 to execute the search.

FIG. 1B shows an example user device 200 in communication with the search system 300 and the auto-download system 400. User devices 200 may be any computing devices that are capable of communicating with a user 10 via a graphical user interface (GUI) 240. In some examples, the user device 200 may be capable of providing queries 210, 212 to the search system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances .

The user devices 200 may use a variety of different operating systems 224. In examples where a user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 224 running on the user device 200 may include, but is not limited to, one of ANDROID®, IOS®, or WINDOWS PHONE®. In an example where a user device 200 is a laptop 200a or desktop computing device 200e, the user device 200 may run an operating system 224 including, but not limited to, MICROSOFT WINDOWS® by Microsoft Corporation, MAC OS® by Apple, Inc., or Linux. User devices 200 may also access the search system 300 and the auto-download system 400 while running operating systems 224 other than those operating systems 224 described above, whether presently available or developed in the future.

A software application 204 may refer to computer software that, when executed by a computing device, causes the computing device to perform a task. In some examples, a software application 204 may be referred to as an “application”, an “app”, or a “program”. Example software applications 204 include, but are not limited to, word processing applications, spreadsheet applications, messaging applications, media streaming applications, social networking applications, and games.

Applications 204 can be executed on a variety of different user devices 200. In some examples, a native application 204a may be installed on a user device 200 prior to a user 10 purchasing the user device 200. In other examples, the user may 10 download and install native applications 204a on the user device 200.

The functionality of an application 204 may be accessed on the computing device 200 on which the application 204 is installed. Additionally or alternatively, the functionality of an application 204 may be accessed via a remote computing device 112. In some examples, all of an application's functionality is included on the computing device 112, 200 on which the application 204 is installed. These applications 204 may function without communicating with other computing devices 112, 200 (e.g., via the network 120). In other examples, an application 204 installed on a computing device 200 may access information from other remote computing devices 112 during operation. For example, a weather application installed on a computing device 200 may access the latest weather information via the Internet (e.g., network 120) and display the accessed weather information to the user 10 through the installed weather application. In still other examples, a web-based application 204b (also referred to herein as a web application) may be partially executed by the user's computing device 200 and partially executed by a remote computing device 112. For example, a web application 204b may be an application 204 that is executed, at least in part, by a web server and accessed by a web browser (e.g., a native application 204a) of the user's computing device 200. Example web applications 204b may include, but are not limited to, web-based email, online auctions, and online retail sites.

In general, the user device 200 may communicate with the search system 300 using any software application 204 that can transmit search queries 212 to the search system 300. In some examples, the user device 200 runs a native application 204a that is dedicated to interfacing with the search system 300, such as a native application 204a dedicated to searches (e.g., a search application 216). In some examples, the user device 200 communicates with the search system 300 using a more general application 204, such as a web-browser application 204b accessed using a web browser native application 204a. Although the user device 200 may communicate with the search system 300 using the native search application 216 and/or a web-browser application 204b, the user device 200 may be described hereinafter as using the native search application 216 to communicate with the search system 300. In some implementations, the functionality attributed to the search application 216 may be included as a search component of a larger application 204 that has additional functionality. For example, the functionality attributed to the search application 216 may be included as part of a native application 204a or a web application 204b as a feature that provides search capabilities.

Native applications 204a can perform a variety of different functions for a user 10. For example, a restaurant reservation application can make reservations for restaurants. As another example, an internet media player application can stream media (e.g., a song or movie) from the network 120. In some examples, a single native application 204a can perform more than one function. A restaurant reservation application may also allow a user to retrieve information about a restaurant and read user reviews for the restaurant in addition to making reservations. As yet another example, an internet media player application may also allow a user to perform searches for digital media, purchase digital media, and generate media playlists.

In some implementations, the user device 200 executes one or more software applications 204. A software application 204 may refer to computer software that, when executed by a computing device, causes the computing device to perform a task. In some examples, a software application 204 is referred to as an “application”, an “app”, or a “program”. Example software applications 204 include, but are not limited to, word processing applications, spreadsheet applications, messaging applications, media streaming applications, social networking applications, reference applications, travel related applications, and games.

Applications 204 may be executed on a variety of different user devices 200. In some examples, a native application 204a is installed on a user device 200 prior to the user 10 purchasing the user device 200. In other examples, the user may 10 download and install native applications 204a on the user device 200.

Referring back to FIG. 113, the data sources 130 may include a variety of different data providers. The data sources 130 may include data from application developers 130a, such as application developers' websites and data feeds provided by developers. The data sources 130 may include operators of digital distribution platforms 130b configured to distribute native applications 204a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications 204. Additionally, the data sources 130 may include social networking sites 130e, such as “FACEBOOK®” by Facebook, (e.g., Facebook posts) and “TWITTER®” by Twitter Inc. (e.g., text from tweets). Data sources 130 may also include online databases 130f that include, but are not limited t), data related to movies, television programs, music, and restaurants. Data sources 130 may also include additional types of data sources in addition to the data sources described above. Different data sources 130 may have their own content and update rate.

The search system 300 retrieves data acquired from one or more of the data sources 130. The data retrieved from the data sources 130 may include any type of data related to application functionality and/or application states. The search system 300 generates application states 330 based on the data acquired from the data sources 130. In some examples, a human operator manually generates some data included in the application state records 330. The search system 300 may update data included in the application state records 330 over time so that the search system 300 provides up-to-date results 222.

As shown in FIG. 1B, the search system 300 includes the search module 310 in communication with the search data store 320. The search data store 320 may include one or more databases, indices (e.g., inverted indices), tables, files, or other data structures, which may be used to implement the techniques of the present disclosure. The search system 300 may also include the auto-download module 410 in communication with the auto-download data store 420. As previously noted, the auto-download module .410 may be included in the search system 300 or it may be an independent system, such as an auto-download system 400 (as shown in FIG. 1A that includes both the auto-download module 410 and the auto-download data store 420) in communication with the search system 300. The search data store 320 stores application state records 330; while the auto-download data store 420 stores auto-download records 430. The auto-download records 430 include the rules that the system 100 (e.g., search system 300) applies to search results 222 to determine which applications 204 are automatically downloaded on the user device 200 (e.g., temporary memory 206).

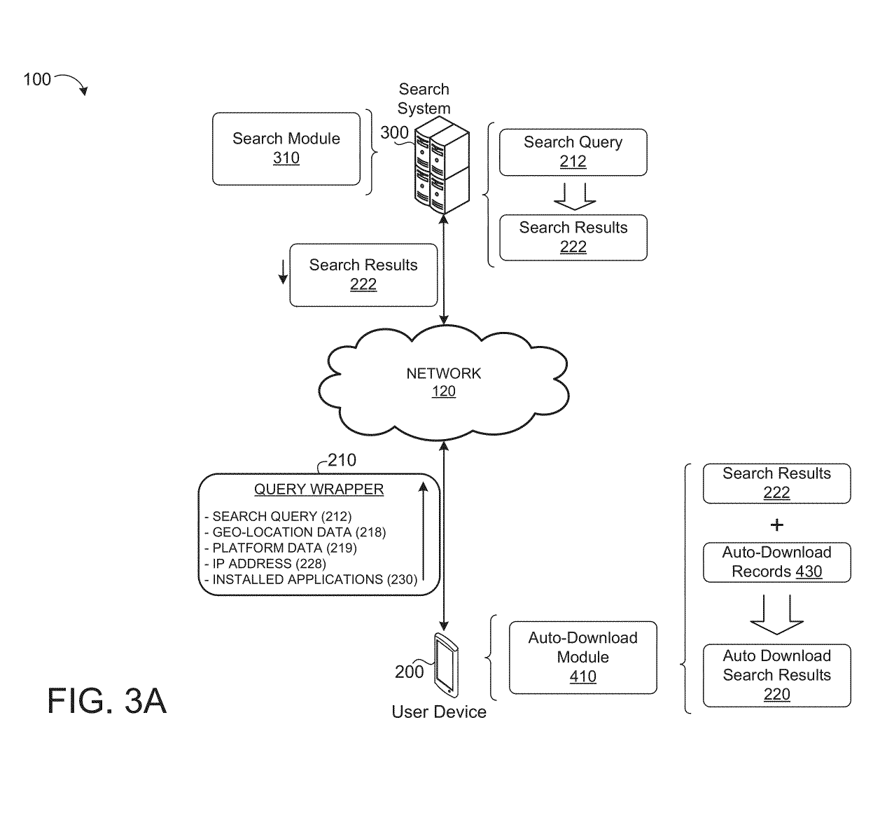

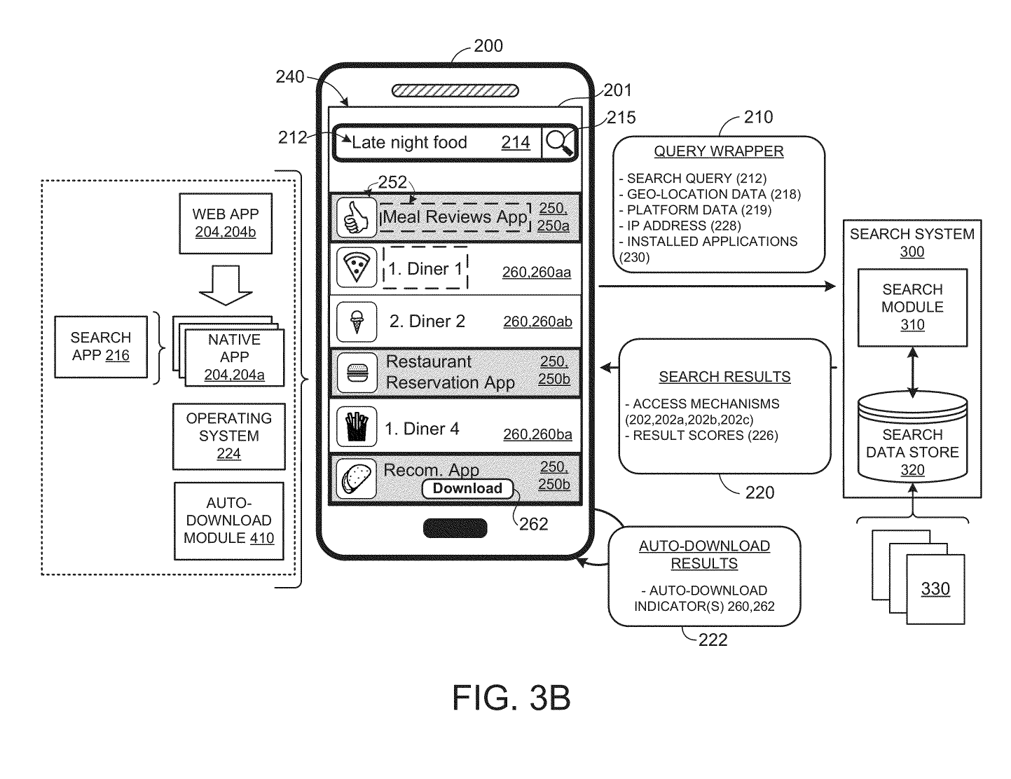

Referring to FIGS. 2A and 2B, the search system 300 determines the auto-download search results 220 based on a received search query 212 and auto-download records 430. While in FIGS. 3A and 3B, the user device 200 requests search results 222 from the search system 300, which the user device 200 uses to identify the auto-download search results 220 based on the search query 212 that the user 10 entered, the received search results 222, and the auto-download records 430 stored on the user device 200. Thus, in FIGS. 3A and 3B, the auto-download module 410 executes on the user device 200, and the user device 200 determines one or more applications 204 that are automatically downloaded in the temporary non-transitory memory 206 of the user device 200.

FIGS. 2A-3B are example architectures of the system 100. In FIGS. 2A and 2B, the search module 310 and the auto-suggest module 410 are part of a search system 300; while in FIGS. 3A and 3B, the auto-download module 410 executes on the user device 200. As previously described, the search system 300 may include the auto-download module 410, or the auto-download module 410 may be part of an auto-download system 400 that is separate from the search system 300 but in communication with the search system 300.

The search module 310 is configured to receive a query wrapper 210 from the user device 200 via the network 120. A query wrapper 210 may include the search query 212, which may include text, numbers, and/or symbols (e.g., punctuation) entered into the user device 200 by the user 10. For example, the user 10 may enter the search query 212 into the search field 214 (e.g., a search box) of the GUI 240 of a search application 216 running on the user device 200. A user 10 may enter a search query 212 using a touchscreen keypad, a mechanical keypad, a speech-to-text program, or other form of user input. In general, a search query 212 may be a request for information retrieval (e.g., search results) from the search system 300. For example, a search query 212 may be directed to retrieving a list 251 of links 250 to application functionality or application states in examples where the search system 300 is configured to generate a list of access mechanisms 202 as search results 222. A search query 212 directed to retrieving a list 251 of links 250 to application functionality may indicate a user's desire to access functionality of one or more applications 204 described by the search query. Moreover, as previously described, a search query 212 may include a selection of a category of applications 204.

The query wrapper 210 may include additional data along with the search query 212. For example, the query wrapper 210 may include geo-location data 218 that indicates the location of the user device 200, such as latitude and longitude coordinates. The user device 200 may include a global positioning system (GPS) receiver that generates the geo-location data 218 transmitted in the query wrapper 210. The query wrapper 210 may also include an IP address 228, which the search module 310 may use to determine the location of the user device 200. In some examples, the query wrapper 210 may also include additional data, including, but not limited to, platform data 219 (e.g., version of the operating system 224, device type, and web-browser version), an identity of a user of the user device 200 (e.g., a username), partner specific data, and other data. In some examples, where the search system 300 includes the intermediate system, the intermediate system adds contextual/historical information about a specific user behavior to the query wrapper 210 to aid the search system 300 in executing the search.

The search module 310 may use the search query 212 and the additional data included in the query wrapper 210 to generate the search results 222. For example, the search module 310 can determine a geo-location of the user device 200, which the search module 310 can use along with the search query 212 to generate the search results 222. The search module 310 may determine the geo-location of the user device 200 based on the geo-location data 218 or other data (e.g., IP address 228) included in the query wrapper 210. In some implementations, the search module 310 detects a location (e.g., a postal address, street name, city name, etc.) specified in the search query 212. (i.e., a query-specified location). In these implementations, the search module 310 uses the query-specified location along with the search query 212 to generate the search results 222. In some examples, the query wrapper 210 includes installed application data 230 that includes data of applications 204 installed on the user device 200.

The search module 310 performs a search for application states 330 included in the search data store 320 in response to the received query wrapper 210 (e.g., in response to the search query 212 and the geo-location data 218). In some implementations, the search module 310 generates result scores 226 for application states 330 identified during the search. The result score 226 associated with an application state record 330 may indicate the relevance of the application state record 330 to the search query 212. A higher result score 226 may indicate that the application state record 330 is more relevant to the search query 212. The search module 310 may retrieve access mechanisms 202 from the scored application state records 330. The search module 310 may transmit a result score 226 along with an access mechanism 202 retrieved from a scored application state record 330 in order to indicate the rank of the access mechanism 202 among other transmitted access mechanisms 202.

An application access mechanism 202a included in an application state 330 may be an application resource identifier or a string that includes a reference to a native application 204a and/or indicates one or more operations for execution by the native application 204a on the user device 200. An application resource identifier may be a string having an application specific scheme. For example, the application resource identifier may include a reference to a native application 204a, a domain name, and a path to be used by the native application 204a to retrieve and display information to the user 10. In some examples, an application resource identifier is an application specific resource identifier that is defined by the developer of the application 204. In this example, the search application 216 receives the application resource identifier and the operating system 224 may send the application resource identifier to the native application 204a referenced in the application resource identifier. The native application 204a that is referenced in the application resource identifier launches and is set into the state specified by the application resource identifier.

In some examples, the application access mechanism 202a includes operations for the user device 200 to perform in addition to the operation(s) indicated in the application resource identifier. For example, the search application 216, the operating system 224, and/or a native application 204a on the user device 200 may perform the operations included in the application access mechanism 202a. In some examples, a script includes the operations. Examples of operations may include, but are not limited to, launching a native application 204a, creating and sending a search request 212 (via a search wrapper 210) to an application server 112, setting a current geographic location in a native application 204a, making a restaurant reservation, sending a text message, and adding an appointment to a calendar.

In some examples, an application access mechanism 202a may not include an application resource identifier. Instead, the application access mechanism 202a includes one or more operations that reference a native application 204a and indicate one or more operations for execution by the user device 200. The one or more operations may include instructions for at least one of the search application 216, the operating system 224, and/or a native application 204a on the user device 200. In response to selection of the application access mechanism 202a, the user device 200 may perform the operations included in the application access mechanism 202a. In some examples, the operations may be included in a script.

In some examples, an application function may not be accessible using an application resource identifier. For example, a function of the application may not include a corresponding application resource identifier that the application 204 may use to perform the function. As another example, some applications 204 may not be configured to receive application resource identifiers. In these examples, an application access mechanism 202 for the native application 204a includes one or more operations that cause the native application to perform the function that may not otherwise be accessible using an application resource identifier. The search application 216 may receive the one or more operations and execute the one or more operations to set the native application 204a into the desired application state. In some examples, the one or more operations include launching the native application 204a along with additional operations for the native application 204a to perform. For example, the search application 216 initially triggers the native application 204a to start and then waits for a period of time for the native application 204a to start. Then the search application 216 may perform additional operations included in the received application access mechanism 202, such as issuing a search instruction to the native application 204a.

In still other examples, a native application 204a may be configured to directly receive the operations transmitted by the search system 300. In these examples, the native application 204a may be launched according to the application access mechanism 202 and then the launched native application 204a may directly perform the operations received from the search system 300.

A single native application 204a can provide a variety of different functionalities. For example, a restaurant reservation application can access reviews for a variety of different restaurants and set up reservations at a variety of different restaurants. Similarly, a travel application can book hotels, book flights, and provide reviews for different travel destinations. The different functionalities associated with a single native application may be accessed using a plurality of different application access mechanisms. For example, with respect to the restaurant reservation application, the search data store 320 may include application states 330 having different application access mechanisms 202 for accessing different restaurant reviews and setting up reservations. Similarly, the search data store 320 may include application states 330 having different application access mechanisms 202 for booking hotels, booking flights, and accessing reviews for different travel destinations.

The application access mechanisms 202 for a single native application 204a may vary in complexity. In some examples, the application access mechanisms 202 may cause a native application 204a to launch (e.g., the operating system 224 may be instructed to launch the application 204) and then perform additional operations after launching, as described above. In other examples, application access mechanisms 202 may cause an application 204 to launch into a default state e.g., a default homepage) without performing any additional operations. An application state 330 including an application access mechanism 202 that causes an application 204 to launch into a default state may be thought of as an access mechanism 202 that is related to the native application 204a, but not any particular state which may be accessed by the application 204.

The search module 310 may transmit additional data to the user device 200 along with the access mechanisms 202 and the result score(s) 226. For example, the search module 310 may transmit data (e.g., link data 252, such as text and/or images) to be included in the user selectable links 250. Data for the user selectable links 250 (e.g., text and/or images) may be referred to herein as “link data” (e.g., link data 252). The user device 200 displays the user selectable links 250 to the user 10 based on received link data 252. Each user selectable link 250 may be associated with an access mechanism 202 included in the search results 222, such that when a user 10 selects a link 250, the user device 200 launches the application 204 referenced in the access mechanism 202 and sets the application 204 into the state specified by the access mechanism 202.

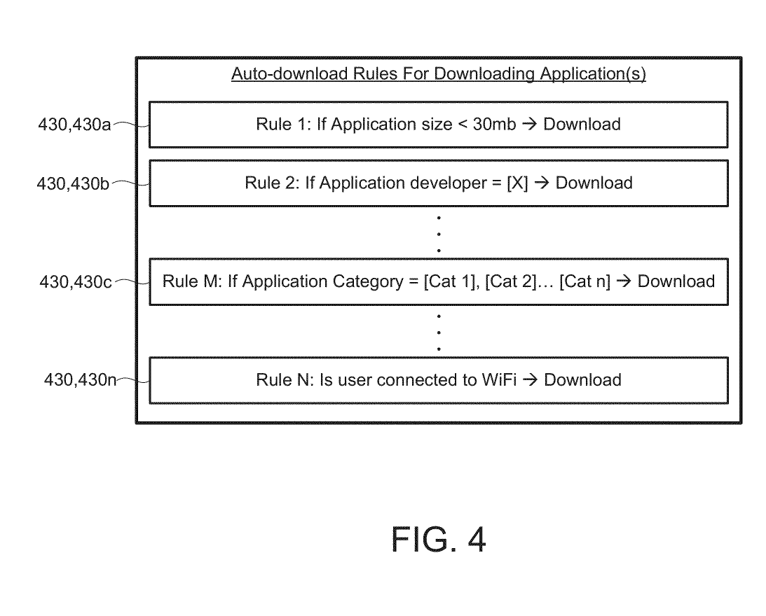

The auto-download module 410 is configured to receive the search results 222 from the search module 310 and determine which search results 222 are automatically downloaded to the user device 200 (e.g., temporary memory 206). The auto-download module 410 is in communication with the auto-download data store 420. The auto-download data store 420 may include data structures, which may be used to implement the techniques of the present disclosure. The auto-download module 410 is configured to solicit from the user 10 (via the GUI 240) one or more parameters or permissions 430 (FIG. 4) that allow the auto-download module 410 to determine the applications 204 that are set to auto-download on the user device 200 from the received search results 222 (received from the search module 310).

The auto-download module 410 may use the search results 222 from the search module 310, the additional data included in the query wrapper 210, and the auto-download records 430 to generate the auto-download search results 220. For example, the auto-download module 410 determines the geo-location of the user device 200, which the auto-download module 410 can use along with the search query 212 to generate the auto-download search results 220. The auto-download module 410 can determine the goo-location of the user device 200 based on the geo-location data 218 or other data e.g., IP address 228) included in the query wrapper 210. In some implementations, the auto-download module 410 detects a location (e.g., a postal address, street name, city name, etc.) specified in the search query 212 (i.e., a query-specified location). In these implementations, the auto-download module 410 uses the query-specified location along with the search query 212 to generate the auto-download search results 220.

Referring to FIG. 4, the auto-download data store 420 stores auto-download records 430 that the auto-download module 410 uses to determine which applications 204 from the search results 222 to automatically download on the user device 200 that are not currently stored on the user device 200. The auto-download module 410 determines the native applications 204a on the user device 200 from the installed application(s) data 230 included in the query wrapper 210. The auto-download module 410 triggers the GUI 240 to provide the user 10 with one or more user-selectable options to determine the auto-download records 430 (e.g., rules). In some implementations, the auto-download module 410 prompts the user 10 to determine a size constraint. For example, referring to RULE 1 430a, the auto-download module 410 determines if an application 204a (installed application data 230, which provides data relating to the applications 204 installed on the user device 200) of the search results 222 has an application size less than a threshold value, in this case 30 Megabytes, then the auto-download module 410 triggers the application 204 to be downloaded on the user device 200. The threshold value is determined by the user 10. Another auto-download record 430b may include Rule 2, which allows the user 10 to specify a developer or application source, and the auto-download module 410 identifies applications 204 from that developer or source as an application set for auto-download to the user device 200. In some examples, each application 204 may include an application category 335a (FIGS. 5A and 5B), the user 10 may select which application categories 335a he/she wants the auto-download module 410 to auto-download (record 430c). In some examples, and to save data costs, the user 10 may specify that the auto-download module 410 only download applications 204 when the user device 10 is connected to the network 120 via WiFi. Other auto-download records or rules 430 may also be available. In some implementations, the auto-download module 410 determines the auto-download results 220 based on one or more auto-download record(s) 430. For example, the auto-download module 410 may determine, for each application 204 in the search results 222, if the application 204 is already installed on the user device 200. Then the auto-download module 410 may determine if the application 204 is less than 30 Megabytes (e.g., auto-download record 430a, Rule 1), if the application 204 has a user identified developer (Rule 2), if the application has one or more user specified categories 335a (Rule M) and if the user device 200 is connected via WiFi (Rule N). If the application 204 meets these requirements, then the auto-download module 410 determines that the application 204 will auto-download on the user device 200. some examples, the user 10 may not want applications 204 to download on his/her user device 200 that require access to resources of the user device 200, such resources may include, but not limited to, accessing the network 120, accessing a user's contacts, accessing Bluetooth setting or using Bluetooth, accessing a user's position (GPS), permission to make and/or receive calls, permission to receive notifications from the application provider, playing music or videos, accessing a music/photo/video library (stored on the user device 200 or the cloud) of the user 10. The auto-download module 410 may solicit from the user 10 (via GUI 240) the resources that the user 10 permits the auto-download applications 204 to access, and the auto-download module 410 sets one or more rules 430 to determine if an application 204 may be auto-downloaded on the user device 200. In some implementations, the auto-download module 410 associates an auto-download indicator 260, 262 with the application 204, which prompts the user device 200 to automatically download the corresponding application 204 to the temporary non-transitory memory 206 of the user device 200.

Referring to FIGS. 5A and 5B, the search data store 320 includes a plurality of different application states 330. Each application state 330 may include data related to a function of an application 204 and/or the state of the application 204 resulting from performance of the function. An application state 330 may include an application state identifier (ID) 332, application state information 334, an application identifier (ID) 336, and one or more access mechanisms 202, 202a, 202b, 202c used to access functionality provided by an application 204.

The application state ID 332 may be used to identify the application state 330 among the other application states 330 included in the search data store 320. The application state ID 332 may be a string of alphabetic, numeric, and/or symbolic characters (e.g., punctuation marks) that uniquely identifies the associated application state 330. In some examples, the application state ID 332 describes a function and/or an application state in human readable form. For example, the application state ID 332 may include the name of the application 204 referenced in the access mechanism(s) 202. In a specific example, an application state ID 332 for an internet music player application may include the name of the internet music player application along with the song name that will be played when the internet music player application is set into the state defined by the application access mechanism included in the application state. Additionally or alternatively, the application state ID 332 may be a human readable string that describes a function performed according to the access mechanism(s) 202 and/or an application state resulting from performance of the function according to the access mechanism(s) 202. In some examples, the application state ID 332 includes a string in the format of a uniform resource locator (URL) of a web access mechanism 202b for the application state 330, which may uniquely identify the application state 330. In some examples, the string may include multiple parameters used to retrieve the corresponding application state 330, In addition, some parameters may be user-generated, which means that the parameters put the application in a new application state 330 that has not been previously executed. Thus, the user-selectable link 250 may not explicitly correspond to a known end result inside the application, but simply fits a known link expression that the application accepts. For example, the UBER application may display a user selectable link 250 that uses a latitude and longitude as a parameter to determine location,

In a more specific example, if the application state 330 describes a function of the YELP® native application, the application state ID 332 may include the name “Yelp” along with a description of the application state described in the application state information 334. For example, the application state ID 332 for an application state 330 that describes the restaurant named “The French Laundry” may be “Yelp—The French Laundry.” In an example where the application state ID 332 includes a string in the format of a URL, the application state ID 332 may include the following string “http://www.yelp.com/biz/the-french-laundry-yountville-2?ob=1” to uniquely identify the application state 330. In additional examples, the application state ID 332 may include a URL using a namespace other than “http://,” such as “func://,” which may indicate that the URL is being used as an application state ID in an application state. For example, the application state ID 332 may include the following string “func://www,yelp.com/biz/the-french-laundry-yountville-2?ob=1.”

The application state information 334 may include data that describes an application state into which an application 204 is set according to the access mechanism(s) 202 in the application state 330. Additionally or alternatively, the application state information 334 may include data that describes the function performed according to the access mechanism(s) 202 included in the application state 330. The application state information 334 may include text, numbers, and symbols that describe the application state. The types of data included in the application state information 334 may depend on the type of information associated with the application state and the functionality specified by the application access mechanism 202a. The application state information 334 may include a variety of different types of data, such as structured, semi-structured, and/or unstructured data. The application state information 334 may be automatically and/or manually generated based on documents retrieved from the data sources 130. Moreover, the application state information 334 may be updated so that up-to-date search results 222 are provided in response to a search query 212.

In some examples, the application state information 334 includes data that may be presented to the user 10 by an application 204 when the application 204 is set in the application state defined by the access mechanism(s) 202. For example, if one of the access mechanism(s) 202 is an application access mechanism 202a, the application state information 334 may include data that describes a state of the native application 204a after the user device 200 has performed the one or more operations indicated in the application access mechanism 202a. For example, if the application state 330 is associated with a shopping application, the application state information 334 may include data that describes products (e.g., names and prices) that are shown when the shopping application is set to the application state defined by the access mechanism(s) 202. As another example, if the application state 330 is associated with a music player application, the application state information 334 may include data that describes a song (e.g., name and artist) that is played when the music player application is set to the application state defined by the access mechanism(s) 202.

The types of data included in the application state information 334 may depend on the type of information associated with the application state and the functionality defined by the access mechanism(s) 202. For example, if the application state 330 is for an application 204 that provides reviews of restaurants, the application state information 334 may include information (e.g., text and numbers) related to a restaurant, such as a category of the restaurant, reviews of the restaurant, and a menu for the restaurant. In this example, the access mechanism(s) 202 may cause the application 204 (e.g., a native application 204a or a web-browser application 204b) to launch and retrieve information relating to the restaurant. As another example, if the application state 330 is for an application 204 that plays music, the application state information 334 may include information relating to a song, such as the name of the song, the artist, lyrics, and listener reviews. In this example, the access mechanism(s) 202 may cause the application 204 to launch and play the song described in the application state information 314.

The search system 300 may generate application state information 334 included in an application state 330 in a variety of different ways. In some examples, the search system 300 retrieves data to be included in the application state information 334 via partnerships with database owners and developers of native applications 204a. For example, the search system 300 may automatically retrieve the data from online databases 130f that include, but are not limited to, data related to movies, television programs, music, and restaurants. In some examples, a human operator manually generates some data included in the application state information 334. The search system 300 may update data included in the application state information 334 over time so that the search system 300 provides up-to-date results 220 to the user 10.

The application ID 336 may be used to identify a native application 204a associated with the application state 330. The application ID 336 may be a string of alphabetic, numeric, and/or symbolic characters (e.g., punctuation marks) that uniquely identifies the associated native application 204a. In some examples, the application ID 336 the native application 204a in human readable form. For example, the application ID 336 may include the name of the application 204 referenced in the access mechanism(s) 202. In some examples, the application ID 336 for a restaurant finder application 204 may include the name of the restaurant finder application.

An application state 330 including an application access mechanism 202 that causes an application 204 to launch into a default state may include application state information 334 describing the native application 204a, instead of any particular application state. For example, the application state information 334 may include the name of the developer of the application 204, the publisher of the application 204, a category 335a (e.g., genre) of the application 204, a description 335b of the application 204 (e.g., a developer's description), and a price of the application 204. The application state information 334 may also include security or privacy data about the application 204, battery usage of the application 204, and bandwidth usage of the application 204. The application state information 334 may also include application statistics. Application statistics may refer to numerical data related to a native application 204a. For example, application statistics may include, but are not limited to, a number of downloads, a download rate (e.g., downloads per month), a number of ratings, and a number of reviews.

FIG. 3B shows an example application state 330 associated with the OPENTABLE® application, developed by OpenTable, Inc. The OPENTABLE® application is a restaurant-reservation application that allows users 10 to search for restaurants and make restaurant reservations. The OPENTABLE® application provides information about restaurants including descriptions of restaurants and user reviews of the restaurants. The example application state 330 of FIG. 3B describes an application state of the OPENTABLE® application in which the OPENTABLE® application accesses information for THE FRENCH LAUNDRY® restaurant.

The example application state 330 includes an application state ID 332 of “OPENTABLE—THE FRENCH LAUNDRY,” which may be used as a unique identifier to identify the application state 330. In other examples, the application state ID 332 includes a URL as a unique identifier for the application state 330. For example, the application state ID 332 may include the string “http://www.opentable.com/the-french-laundry” as a unique identifier for the application state 330. As described herein, such an application state ID 330 may be included in a web access mechanism 202b of an application state 330. As another example, the application state ID 332 may have a different namespace than “http://,” such as “func://.” In yet another example, the application state ID 332 could be a string of characters, numbers, and/or symbols that are not in human readable form. Each example is optional and may be combined with other examples.

The example application state information 334 includes data fields 335, such as a category 335a of THE FRENCH LAUNDRY® restaurant, a description 335b of THE FRENCH LAUNDRY® restaurant, user reviews 335c of THE FRENCH LAUNDRY® restaurant, and additional data fields 335. The restaurant category 335a field may include the text “French cuisine” and “contemporary,” for example. The description field 335b may include text that describes THE FRENCH LAUNDRY® restaurant. The user reviews field 335c may include text of user reviews for THE FRENCH LAUNDRY® restaurant. The additional data fields 335 may include additional data for THE FRENCH LAUNDRY® restaurant that may not specifically fit within the other defined fields, such as a menu for the restaurant, prices, and operating hours for the restaurant.

The application state 330 includes one or more access mechanism(s) 202. The access mechanism(s) 202 may include a reference to the OPENTABLE® application 204. An example application access mechanism 202a for the application state 330 may include a reference to the OPENTABLE® native application 204a along with one or more operations to be performed by the user device 200. For example, the application access mechanism 202a may include an application resource identifier and/or one or more operations that cause the user device 200 to access the entry for THE FRENCH LAUNDRY® restaurant in the OPENTABLE® native application. An example application resource identifier may be “vnd.opentable.deeplink://opentable.com/restaurant/profile?rid=1180&refid=1.”

In some implementations, an application state 330 includes multiple different application access mechanisms 202, 202a, 202b, 202c that may include a variety of information. The application access mechanism 202 may include edition information that indicates the application edition with which the application access mechanism 202 is compatible. For example, the edition information indicates the operating system 224 with which the application access mechanism 202 is compatible. Moreover, different application access mechanisms 202 may be associated with different editions of a native application 204a. A native application edition (hereinafter “application edition”) refers to a particular implementation or variation of a native application 204a. For example, an application edition may refer to a version of a native application 204a, such as a version 1.0 of a native application 204a or a version 2.0 of a native application 204a, In another example, an application edition may refer to an implementation of a native application 204a for a specific platform, such as a specific operating system 224.

The different application access mechanisms 202 included in an application state 330 may cause the corresponding application editions to launch and perform similar functions. Accordingly, the different application access mechanisms 202 included in an application state 330 may cause the corresponding application editions to be set into similar application states. For example, if the different application access mechanisms 202 reference different editions of an information retrieval application, the different application access mechanisms 202 may cause the corresponding application editions to retrieve similar information. In another example, if the different application access mechanisms 202 reference different editions of an internet music player application, the different application access mechanisms 202 may cause the corresponding application editions to play the same song.

In some examples, an application state 330 for a native application that retrieves restaurant information may include multiple different application access mechanisms 202 for multiple different application editions. Assuming the application state record 330 is associated with a specific Mexican restaurant, the application access mechanisms 202 for the different application editions may cause each application edition to retrieve information for the same specific Mexican restaurant. For example, a first application access mechanism 202 may cause a first application edition (e.g., on a first operating system) to retrieve information for the specific Mexican restaurant. A second application access mechanism 202 may cause a second application edition (e.g., on a second operating system) to retrieve information for the specific Mexican restaurant. In some examples, the search system 300 can determine whether to transmit the application access mechanism 202 in the search results 222 based on whether the user device 200 is configured to receive the application access mechanism 202.

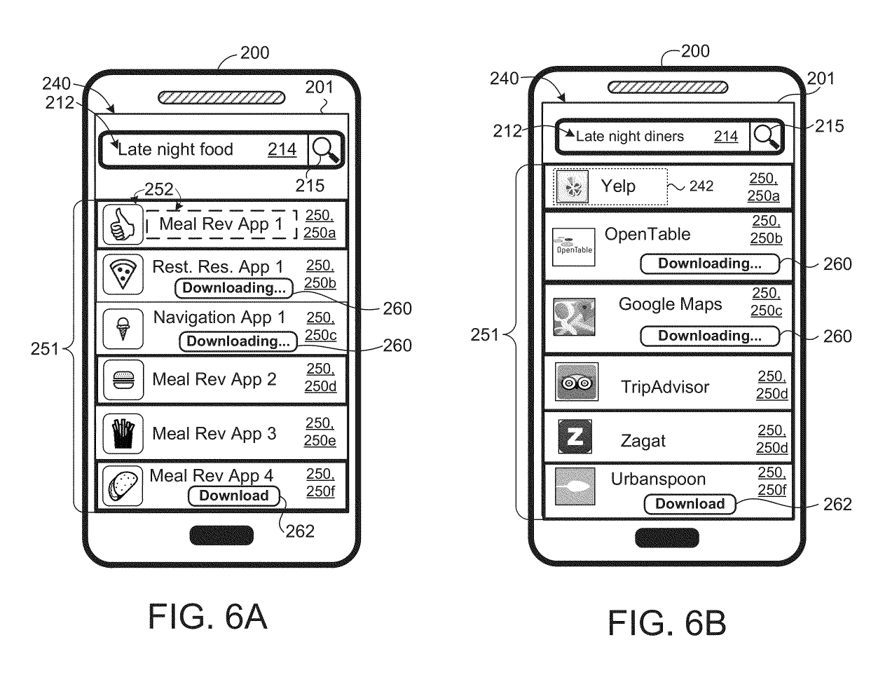

Referring to FIGS. 6A and 63, the user device 200 may receive a set of auto-download search results 220 from the search module 310 and/or the auto-download module 410 in response to transmission of the query wrapper 210 to the search system 300. The GUI 240 of the search application 216 displays (e.g., renders) the auto-download search results 220 received from the search module 310. The search application 216 may display the search results 222 to the user in a variety of different ways, depending on what information is transmitted to the user device 200. In examples where the search results 222 include a list 251 of access mechanisms 202 and link data 252 associated with the access mechanisms 202, the search application 216 may display the auto-download search results 220 to the user 10 as a list of user selectable links 250 including text and images. The text and images in the links 250 may include application names associated with the access mechanisms 202, text describing the access mechanisms 202, images associated with the application 204 referenced by the access mechanisms 202 (e.g., application icons), and images/text/or other data associated with the application state (e.g., application screen images) defined by the access mechanisms 202. In response to a selection of a link 250 (e.g., touching or clicking the link 250), the user device 200 may launch a corresponding software application 204 (e.g., a native application 204a previously installed on the user device 200 or installed in the temporary memory 206) or a web-browser application 204b referenced by the access mechanism 202 and performs one or more operations indicated by the access mechanism 202.

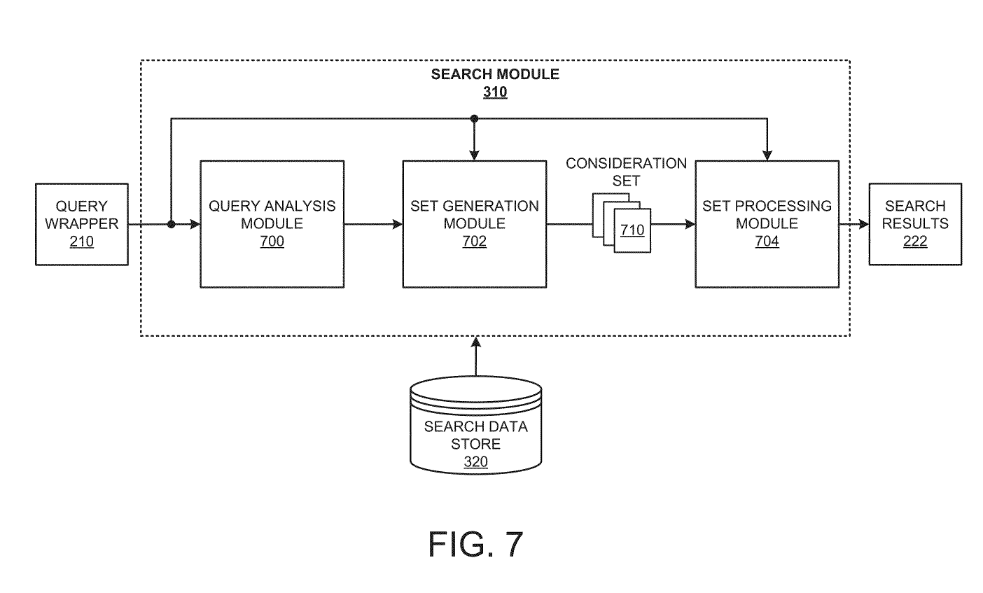

In some implementations, the search application 216 displays the auto-download search results 220 as a list 251 of links 250 arranged under the search field 214 in which the user 10 entered the search query 212. Moreover, the search application 216 may arrange the links 250 based on result scores 226 (FIG. 7) associated with the access mechanisms 202 included in the links 250. In some examples, the search application 216 groups the links 250 together if the links 250 are related to applications 204 having functionality (e.g., restaurant review application).

Each link 250 includes link data 252. For example, each link 250 includes an image (e.g., an icon) and text (e.g., an application name or a business name) that may describe an application 204 and a state of an application 204. Each of the links 250 may include an access mechanism 202 so that if a user 10 selects one of links 250, the user device 200 launches the application 204 and sets the application 204 into a state that is specified by the access mechanism 202 associated with the selected link 250. In some implementations, the user device 200 may arrange the links 250 based on result scores 226 associated with the access mechanisms 202 included in the links 250. In some implementations, as illustrated in FIG. 2, links 250 for the same application 204 may be combined together in the auto-download search results 220 displayed to the user 10.

In some examples, applications 204 that the auto-download module 410 indicates for downloading may include a download status 260 as they are downloading. The auto-download module 410 may include a downloadable status 262 for applications 204 that are not downloaded on the user device 200, because the user device 200 includes an application 204 that includes similar functionality. In such a case, the user 10 may select the download indicator 262 and the user device 200 initiates a download of the application 204 associated with the download button 262. Moreover, when the user 10 selects the download button 262, the application 204 may be stored in either the temporary memory 206 or the permanent memory 208.

With continued reference to FIGS. 6A and 6B, the GUI 240 may display first, second, third and fourth meal review application links 250a, 250d, 250e, 250f (e.g., YELP®, TRIPADVISOR®, ZAGAT®, and URBANSPOON®), a restaurant reservation application 250b (e.g., OPENTABLE®), and a navigation application link 250c (e.g., Google Maps). The first, second, and third meal review application links 250a, 250d, 250e do not have an indicator 260 or a download status 262 associated with them. Therefore, these applications 204 are native applications 204a and are already stored on the user device 200 (permanent memory 208). The first restaurant reservation application 250b includes a downloading indicator 260 signifying that the auto-download module 410 indicates that the application meets the auto-download records 430 specified by the user 10. Therefore, when a download button 262 is available for the user 10 to select, then the application 204 associated with the link 250f was not recommended for auto-download based on one or more reasons, which include, but are not limited to, the fact that an application 204 having a similar functionality is already downloaded on the user device 200 (e.g., Meal review application1, meal review application 2, and meal review application 3) or because the application 204 did not meet the auto-download rules 430 specified by the auto-download records 430.

FIG. 7 shows an example search module 310 that includes a query analysis module 700, a consideration set generation module 702 (hereinafter “set generation module 702”), and a consideration set processing module 704 (hereinafter “set processing module 704”). The query analysis module 700 receives the query wrapper 210 and analyzes the received search query 212 of the query wrapper. The query analysis module 700 may perform various analysis operations on the received search query 212, which may include, but are not limited to, tokenization of the search query 212, filtering of the search query 212, stemming, synonymization, and stop word removal. In some implementations, the query analysis module 700 detects a query-specified location included in the search query 212.

The set generation module 702 identifies a plurality of application state records 330 based on the received search query 212. In some examples, the set generation module 702 identifies the application state records 330 based on matches between terms of the search query 212 and terms in the application state records 330. For example, the set generation module 702 may identify the application state records 330 based on matches between tokens generated by the query analysis module 700 and words included in the application state records 330, such as words included in the application state Ms 332 and/or the application state information 334. In some implementations, the search results 222 includes application state records 330 that were not analyzed by the set generation module 702.

The consideration set 710 of application state records 330 may refer to the application state records 330 that are to be scored by the set processing module 704. The set generation module 702 may determine the geo-location of the user device 200 based on data included in the query wrapper 210 (e.g., geo-location data 218, or IP address 228). In additional examples, if the query analysis module 700 detects a query-specified location, the set generation module 702 uses the query-specified location as the search location. In some examples, the set generation module 702 uses the geo-location of the user device 200 as the search location (e.g., to fitter application state records 330 based on location).

The set processing module 704 may score the application state records 330 in the consideration set 710 in order to generate a set of consolidated results 222. The scores 226 associated with the application state records 330 may be referred to as “result scores.” The set processing module 704 may determine a result score 226 for each of the application state records 330 in the consideration set 710. The result scores 226 associated with an application state record 330 may indicate the relative rank of the application state record 330 (e.g., by the access mechanisms 202) among other application state records 330. For example, a larger result score 226 may indicate that application state record 330 is more relevant to the received search query 212.

The set processing module 704 selects application access mechanisms 202 from the selected application state records 330 (e.g., the highest scoring application state records 330). The set processing module 704 transmits the selected application access mechanisms 202 to the user device 200 that generated the search query 212. The set processing module 704 may also transmit the result scores 226 associated with the selected application access mechanisms 202 to the user device 200. For example, an application access mechanism 202 may he associated with the result score 226 of the application state record 330 from which the application access mechanism 202 was selected.

The information conveyed by the consolidated results 222 may depend on how the result scores 226 are calculated by the set processing module 704. For example, the result scores 226 may indicate the relevance of an application function or application state to the search query 212, the popularity of an application function or state, or other properties of the application function or state, depending on what parameters the set processing module 704 uses to score the application state records 330.

The set processing module 704 may generate result scores 226 fix application state records 330 in a variety of different ways. In some implementations, the set processing module 704 generates a result score 226 for an application state record 330 based on one or more scoring features. The scoring features may be associated with the application state record 330 and/or the search query 212. A function record scoring feature (hereinafter “record scoring feature”) may be based on any data associated with an application state record 330. For example, record scoring features may be based on any data included in the application state information 344 of the application state record 330. Example record scoring features may be based on metrics associated with a person, place, or thing described in the application state record 330. Example metrics may include the popularity of a place described in the application state record 330 and/or ratings (e.g., user ratings) of the place described in the application state record 330. For example, if the application state record 330 describes a song, a metric may be based on the popularity of the song described in the application state record 330 and/or ratings (e.g., user ratings) of the song described in the application state record 330. The record scoring features may also be based on measurements associated with the application state record 330, such as how often the application state record 330 is retrieved during a search and how often access mechanisms 202 of the application state record 330 are selected by a user 10. Record scoring features may also be based on whether the application state record 330 includes an application access mechanism 202 that leads to a default state or a deeper native application state.

A query scoring feature may include any data associated with the search query 212. For example, query scoring features may include, but are not limited to, a number of words in the search query 212, the popularity of the search query 212, and the expected frequency of the words in the search query 212. A record-query scoring feature may include any data generated based on data associated with both the application state record 330 and the search query 212 that resulted in the identification of the application state record 330 by the set generation module 702. For example, record-query scoring features may include, but are not limited to, parameters that indicate how well the terms of the search query 212 match the terms of the application state information 344 of the identified application state record 330. The set processing module 704 may generate a result score 226 for an application state record 330 based on at least one of the record scoring features, the query scoring features, and the record-query scoring features.

The set processing module 704 may determine a result score 226 for an application state record 330 based on one or more of the scoring features listed herein and/or additional scoring features not explicitly listed. In some examples, the set processing module 704 may include one or more machine learned models (e.g., a supervised learning model) configured to receive one or more scoring features. The one or more machine learned models may generate result scores 226 based on at least one of the record scoring features, the query scoring features, and the record-query scoring features. For example, the set processing module 704 may pair the search query 212 with each application state record 330 and calculate a vector of features for each (query, record) pair. The vector of features may include one or more record scoring features, one or more query scoring features, and one or more record-query scoring features. The set processing module 704 may then input the vector of features into a machine-learned regression model to calculate a result score 226 for the application state record 330. In some examples, the machine-learned regression model may include a set of decision trees (e.g., gradient boosted decision trees). In another example, the machine-learned regression model may include a logistic probability formula. In some examples, the machine learned task is framed as a semi-supervised learning task, where a minority of the training data is labeled with human curated scores and the rest are used without human labels.

The result scores 226 associated with the application state records 330 (e.g., access mechanisms 202) may be used in a variety of different ways. The set processing module 704 and/or the user device 200 may rank the access mechanisms 202 based on the result scores 226 associated with the access mechanisms 202. In these examples, a larger result score may indicate that the access mechanism 202 (e.g., the function or application state) is more relevant to a user than an access mechanism 202 having a smaller result score. In examples where the user device 200 displays the consolidated results 222 as a list, the user device 200 may display the links 250 for access mechanisms 202 having larger result scores 226 nearer to the top of the results list (e.g., near to the top of the screen). In these examples, the user device 200 may display the links 250 for access mechanisms 202 having lower result scores 226 farther down the list (e.g., off screen) in such a case, the user 10 scrolls down the list 251 to view the links 250 associated with the access mechanisms 202 having the lower scores 226. In some examples, as illustrated in FIG. 2, the user device 200 groups together the links 250 associated with the same native application 204a, other groupings are possible as well.

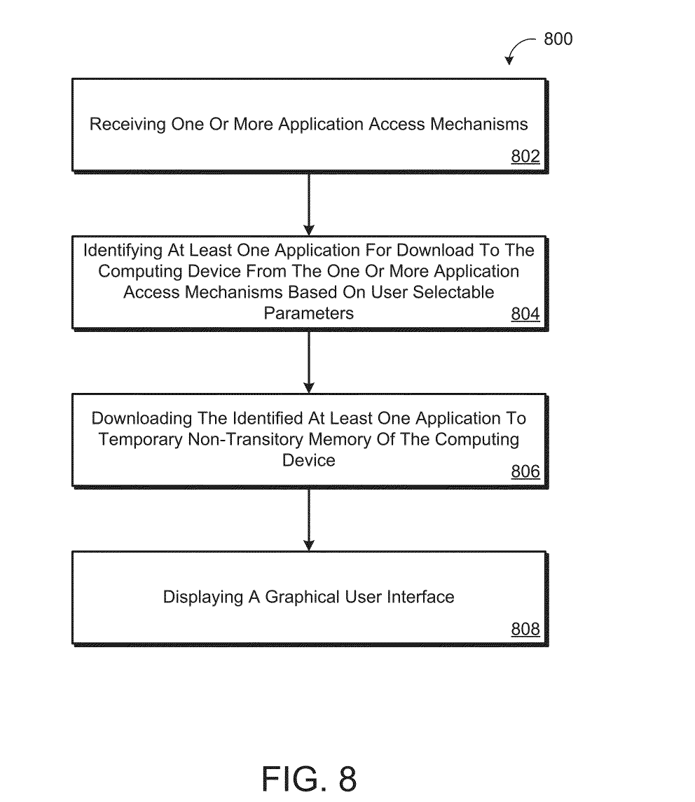

FIG. 8 provides an example arrangement of operations for a method 800 of automatically downloading an application 204 (or more) to a user device 200 of the system 100 of FIGS. 1A and 1B. At block 802, the method 800 includes receiving, at a computing device (e.g., user device 200), one or more application access mechanism 202. At block 804, the method 800 includes identifying at least one application 204 for downloading to the user device 200 from the one or more application access mechanisms 202 based on user selectable parameters (e.g., auto-download records 430). Each application access mechanism 202 is associated with an application 204 executable on the user device 200 and indicates an operation to download the application 204 (e.g., a download status 260 for automatic downloading or a download button 262) to the user device 200. The user selectable parameters may include one or more user defined rules 430 associated with the user device 200 and/or the identified at least one application 204. For example, referring to FIG. 4, the auto-download data store 420 may store one or more auto-download records 430 that specify the permissions or parameters that an application 204 should meet to be identified as an application 204 for automatic download on the user device 200. At block 806, the method 800 includes downloading the identified at least one application 204 to temporary non-transitory memory 206 of the user device 200 using, for each identified application 204, the operation of the corresponding application access mechanism 202. The identified application 204 is stored in the temporary non-transitory memory 206 of the user device 200 until the user 10 indicates that he/she wants to permanently keep and use the application 204, then the user device 200 or the system 300 stores the application 204 as a native application 204a in the permanent non-transitory memory of the user device 200. At block 808, the method 800 includes displaying, on a display 201 in communication with the user device 200, a GUI 240. For each identified application 204, the GUI 240 displays an associated user selectable 250 referencing the corresponding application 204.

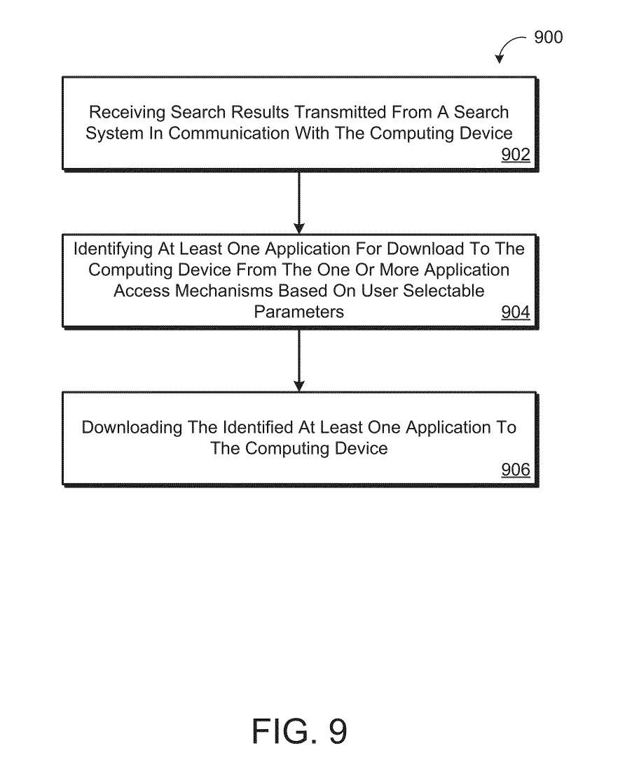

FIG. 9 provides an example arrangement of operations for a method 900 of automatically downloading an application 204 to a user device 200 of the system of FIGS. 1A. At block 902, the method 900 includes receiving, at a computing device (e.g., user device 200), search results 220, 222 transmitted from a search system 300 in communication with the computing device (e.g., user device 200). At block 904, the method 300 includes identifying, at the user device 200, at least one application 204 for download to the user device 200 from the one or more application access mechanisms 202 based on the user selectable parameters. The search results include one or more application access mechanisms 202. Each application access mechanism 202 is associated with an application 204 executable on the user device 200 and indicating an operation to download the application 204 to the user device 200. The user selectable parameters include one or more user defined rules associated with the user device 200 and/or the identified at least one application 204. At block 906, the method 900 further includes downloading the identified at least one application 204 to the computing device (e.g., user device 200) using, for each identified application 204, the operation of the corresponding application access mechanism 202.

Referring back to FIGS. 8 and 9, the user selectable parameters include one or more of an application size, a user device connection to a network 120, an application category, an application developer, or an application user review (e.g., average user rating, or minimum number of stars associated with an application). The GUI 240 may include an indication 260 of a download progress of the identified at least one application 204. The methods 800, 900 may further include receiving, at the user device 200, a selection of a user selectable link 250, and executing an application 204 referenced by the user selectable link 250. Additionally, or alternatively, the operations may further include, when executing the application 204, receiving, at the user device 200, a permission request including an access permission 202 allowing the application 204 to access information on the user device 200. The method 800, 900 further includes displaying in the GUI 240 one or more user selectable permissions. Each user selectable permission is associated with a permission request. The methods 800, 900 may also include receiving, at the user device 200, a selection of one or more user selectable permissions. In some examples, the method 800, 900 includes, when downloading the identified at least one application 204 to the temporary non--transitory memory 206, associating a download start time with the identified at least one application 204. The method 800, 900 may further include, for each application 204 downloaded to the temporary non--transitory memory 206, deleting the application 204 from the temporary non-transitory memory 206 after a threshold period of time after the associated download start time or end time, or after one or more measurements have been satisfied. In other examples, method 800, 900 may further include, for each application 204 downloaded to the temporary non-transitory memory 206, moving the application 204 from the temporary non-transitory memory 206 to permanent non-transitory memory 208 in communication with the device 200.

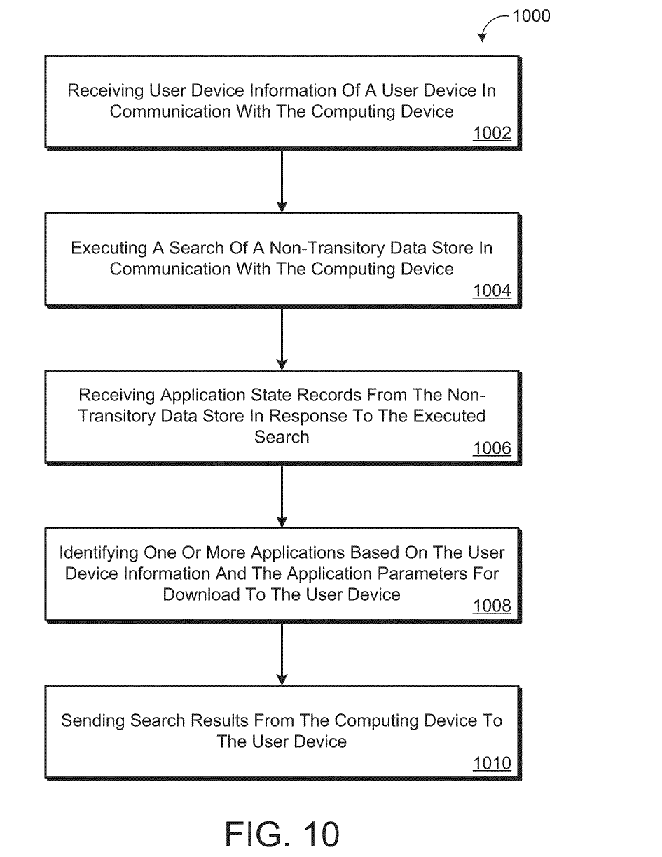

FIG. 10 provides an example arrangement of operations for a method 1000 of performing a search using the system 100 of FIGS. 1A and 1B. At block 1002, the method 1000 includes receiving, at a computing device 112, user device information of a user device 200 in communication with the computing device 112, at block 1004, executing, using the computing device 112, a search of non-transitory data store in communication with the computing device 112, using a search criteria, and at block 1006, receiving, at the computing device 112, application state records from the non-transitory data store in response to the executed search. Each application state record 330 includes an application access mechanism 202 and has a reference to a corresponding application 204 executable on the user device 200 and indicating an operation for downloading and installing the corresponding application 204 on the user device 200 and application information describing application parameters associated with the corresponding application 204. At block 1008, the method 1000 further includes identifying one or more applications 204 based on the user device 200 information and the application parameters for download to the user device 200 and at block 1010, sending search results from the computing device 112 to the user device 200. The search results 220, 222 include an application access mechanism 202 for each identified application 204.

In some implementations, the method 1000 includes receiving, at the computing device 112, user selectable parameters. Identifying the one or more applications 204 further includes identifying the one or more applications 204 based on the user device information, the application parameters, and the user selectable parameters. The user selectable parameters may include one or more of an application size, a user device connection to a network, an application category, an application developer, or an application user review. Each application access mechanism 202 of the search results may include a trigger instructing the user device 200 to automatically download the corresponding application 204 on the user device 200. The method 1000 may further include receiving, at the computing device 112, the search criteria from the user device 200 or determining the search criteria based on one or more application parameters.

As described in the application, the temporary and permanent non-transitory memory 204, 206 is part of the user device 200. However, in some implementations, the non-transitory memory 204, 206 may be associated with a virtual machine (not shown). A virtual machine (VM) is an emulation of a particular computer system (e.g., a user device 200) and operates based on the computer architecture. In addition, the VM is implemented based on the particular computer system, which may in some examples be a specialized computer system.

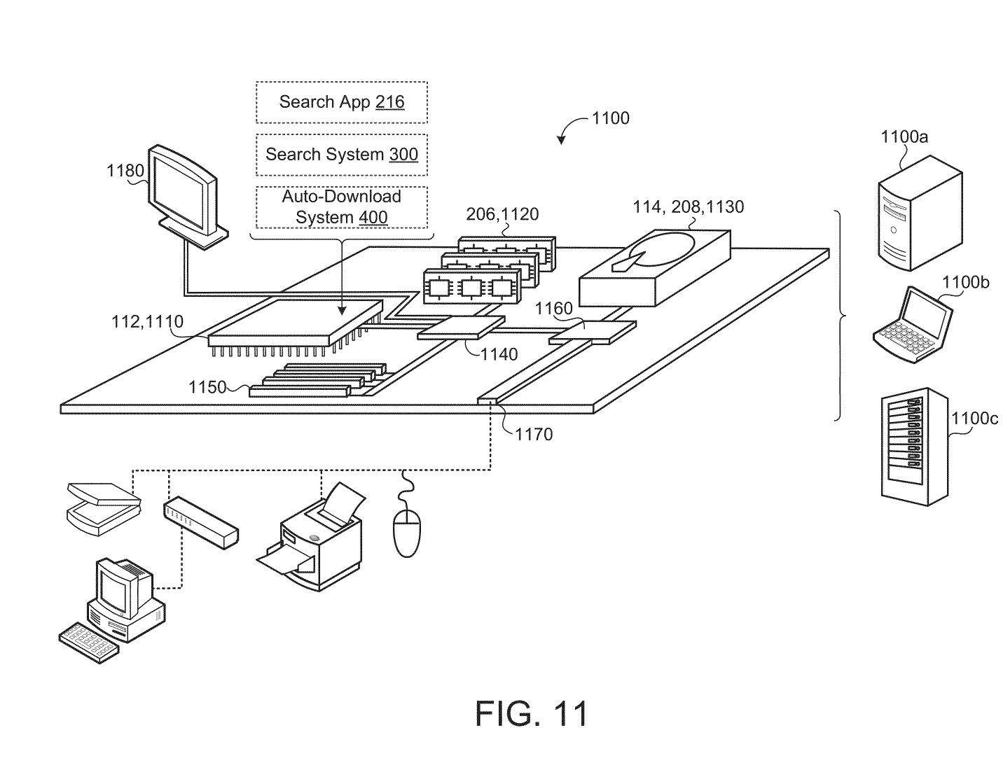

FIG. 11 is schematic view of an example computing device 1100 that may be used to implement the systems and methods described in this document. The computing device 1100 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1100 includes a processor 112, 1110, memory 206, 1120, a storage device 114, 288, 1130, a high-speed interface/controller 1140 connecting to the memory 1120 and high-speed expansion ports 1150, and a low speed interface/controller 1160 connecting to low speed bus 1170 and storage device 114, 288, 1130. Each of the components 1110, 1120, 1130, 1140, 1150, and 1160, are interconnected using various busses, and may be mounted on a common motherboard or in other manners as appropriate. The processor 112, 1110 can process instructions for execution within the computing device 1100, including instructions stored in the memory 1120 or on the storage device 114, 288, 1130 to display graphical information for a graphical user interface (GUI) on an external input/output device, such as display 1180 coupled to high speed interface 1140. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1120 stores information non-transitorily within the computing device 1100. The memory 1120 may be a computer-readable medium, a volatile memory unit(s), or non-volatile memory unit(s). The non-transitory memory 1120 may be physical devices used to store programs (e.g., sequences of instructions) or data (e.g., program state information) on a temporary or permanent basis for use by the computing device 1100. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 114, 288, 1130 is capable of providing mass storage for the computing device 1100. In some implementations, the storage device 114, 288, 1130 is a computer-readable medium. In various different implementations, the storage device 114, 288, 1130 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1120, the storage device 114, 288, 1130, or memory on processor 112, 1110.

The high speed controller 1140 manages bandwidth-intensive operations for the computing device 1100, while the low speed controller 1160 manages lower bandwidth-intensive operations. Such allocation of duties is exemplary only. In some implementations, the high-speed controller 1140 is coupled to the memory 1120, the display 1180 (e.g., through a graphics processor or accelerator), and to the high-speed expansion ports 1150, which may accept various expansion cards (not shown). In some implementations, the low-speed controller 1160 is coupled to the storage device 114, 288, 1130 and low-speed expansion port 1170. The low-speed expansion port 1170, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1100 may be implemented in a number of different forms, as shown in the figure. For example, it may be implemented as a standard server 1100a or multiple times in a group of such servers 1100a, as a laptop computer 1100b, or as part of a rack server system 1100c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form. of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at data processing hardware, one or more application access mechanisms, each application access mechanism associated with an application executable on the data processing hardware and indicating an operation to download the application to the data processing hardware;
identifying, by the data processing hardware, at least one application for download to the data processing hardware from the one or more application access mechanisms based on user selectable parameters, the user selectable parameters comprising one or more user defined rules associated with the data processing hardware and/or the identified at least one application;
downloading the identified at least one application to a first allocation of non-transitory memory in communication with the data processing hardware using, for each identified application, the operation of the corresponding application access mechanism; and
displaying, on a display in communication with the data processing hardware, a graphical user interface including, for each identified application, an associated user selectable link referencing the corresponding application.

2. The method of claim 1, wherein the user selectable parameters include one or more of an application size, a user device connection to a network, an application category, an application developer, or an application user review.

3. The method of claim 1, wherein the graphical user interface includes an indication of a download progress of the identified at Least one application.

4. The method of claim I, further including:
receiving, at the data processing hardware, a selection of a user selectable link; and
executing, by the data processing hardware, an application referenced by the user selectable link.

5. The method of claim 4, further comprising:
when executing the application:
receiving, at the data processing hardware, a permission request comprising an access permission to allow the application to access information on the user device;
displaying in the graphical user interface one or more user selectable permissions, each user selectable permission associated with a permission request; and
receiving, at the data processing hardware, a selection of one or more user selectable permissions.

6. The method of claim I, further comprising when downloading the identified at least one application to the first allocation of non-transitory memory, associating a download start time with the identified at least one application.

7. The method of claim 6, further comprising, for each application downloaded to the first allocation of non-transitory memory:
deleting the application from the first allocation of non-transitory memory after threshold period of time after the associated download start time; or
moving the application from the first allocation of non-transitory memory to a second allocation of non-transitory memory in communication with the data processing hardware.

8. The method of claim 7, wherein the first allocation of non-transitory memory comprises temporary non-transitory memory and the second allocation of non-transitory memory comprise permanent non-transitory memory.

9. A user device comprising:
a display;
data processing hardware in communication the display; and
non-transitory memory in communication with the data processing hardware, the non-transitory memory storing instructions that when executed on the data processing hardware cause the data processing hardware to perform operations comprising:
receiving one or more application access mechanisms, each application access mechanism associated with an application executable on the data processing hardware and indicating an operation to download the application to the data processing hardware;
identifying at least one application for download to the data processing hardware from the one or more application access mechanisms based on user selectable parameters, the user selectable parameters comprising one or more user defined rules associated with the data processing hardware and/or the identified at least one application;
downloading the identified at least one application to first allocation of non-transitory memory using, for each identified application, the operation of the corresponding application access mechanism; and
displaying on the display a graphical user interface including, for each identified application, an associated user selectable link referencing the corresponding application.

10. The user device of claim 9, wherein the user selectable parameters include one or more of an application size, a user device connection to a network, an application category, an application developer, or an application user review.

11. The user device of claim 9, wherein the graphical user interface includes an indication of a download progress of the identified at least one application.

12. The user device of claim 9, wherein the operations further comprise, when executing the application:
receiving a permission request comprising an access permission to allow the application to access information on the user device;
displaying in the graphical user interface one or more user selectable permissions, each user selectable permission associated with a permission request; and
receiving a selection of one or more user selectable permissions.

14. The user device of claim 9, wherein the operations further comprise when downloading the identified at least one application to the first allocation of non-transitory memory, associating a download stall time with the identified at least one application.

15. The user device of claim 9, wherein the operations further comprise, for each application downloaded to the first allocation of non-transitory memory:
deleting the application from the first allocation of non-transitory memory after a threshold period of time after the associated download start time; or
moving the application from the first allocation of non-transitory memory to second allocation of non-transitory memory in communication with the data processing hardware.

16. The user device of claim 15, wherein the first allocation of non-transitory memory comprises temporary non-transitory memory and the second allocation of non-transitory memory. comprise permanent non-transitory memory.

17. A method comprising:
receiving, at data processing hardware, search results transmitted from a search system in communication with the data processing hardware, the search results comprising one or more application access mechanisms, each application access mechanism associated with an application executable on the data processing hardware and indicating an operation to download the application to the data processing hardware;
identifying, at the data processing hardware, at least one application for download to the data processing hardware from the one or more application access mechanisms based on user selectable parameters, the user selectable parameters comprising one or more user defined rules associated with the data processing hardware and/or the identified at least one application; and
downloading the identified at least one application to the data processing hardware using, for each identified application, the operation of the corresponding application access mechanism.

18. The method of claim 17, wherein the user selectable parameters include one or more of an application size, a user device connection to a network, an application category, an application developer, or an application user review.

19. The method of claim 17, wherein the graphical user interface includes an indication of a download progress of the identified at least one application.

20. The method of claim 17, wherein the operations further comprise:
receiving, at the data processing hardware, a selection of a user selectable link; and
executing an application referenced by the user selectable link.

21. The method of claim 20, wherein the operations further comprise, when executing the application:
receiving, at the data processing hardware, a permission request comprising an access permission allowing the application to access information on the user device;
displaying in the graphical user interface one or more user selectable permissions, each user selectable permission associated with a permission request; and
receiving, at the data processing hardware, a selection of one or more user selectable permissions.

22. The method of claim 17, further comprising when downloading the identified at least one application to the first allocation of non-transitory memory, associating a download start time with the identified at least one application.

23. The method of claim 22, further comprising, for each application downloaded to the first allocation of non-transitory memory:
deleting the application from the first allocation of non-transitory memory after a threshold period of time after the associated download start time; or
moving the application from the first allocation of non-transitory memory to second allocation of non-transitory memory in communication with the data processing hardware.

24. The method of claim 23, wherein the first allocation of non-transitory memory comprises temporary non-transitory memory and the second allocation of non-transitory memory comprise permanent non-transitory memory.

25. A user device comprising:
a display;
data processing hardware in communication with the display; and
non-transitory memory in communication with the data processing hardware, the non-transitory memory storing instructions that when executed on the data processing hardware cause the data processing hardware to perform operations comprising:
receiving search results transmitted from a search system in communication with the data. processing hardware, the search results comprising one or more application access mechanisms, each application access mechanism associated with an application executable on the data processing hardware and indicating an operation to download the application to the data processing hardware;
identifying at least one application for download to the data processing hardware from the one or more application access mechanisms based on user selectable parameters, the user selectable parameters comprising one or more user defined rules associated with the data processing hardware and/or the identified at least one application; and
downloading the identified at least one application to the data processing hardware using, for each identified application, the operation of the corresponding application access mechanism.

26. The user device of claim 25, wherein the user selectable parameters include one or more of an application size, a user device connection to a network, an application category, an application developer, or an application user review.

27. The user device of claim 25, wherein the graphical user interface includes an indication of a download progress of the identified at least one application.

28. The user device of claim 22, wherein the operations further comprise:
receiving a selection of a user selectable link; and
executing an application referenced by the user selectable link.

29. The user device of claim 28, wherein the operations further comprise, when executing the application:
receiving a permission request comprising an access permission allowing the application to access information on the user device;
displaying in the graphical user interface one or more user selectable permissions, each user selectable permission associated with a permission request; and
receiving a selection of one or more user selectable permissions.

30. The user device of claim 25, wherein the operations further comprise, when downloading the identified at least one application to the first allocation of non-transitory memory, associating a download start time with the identified at least one application.

31. The user device of claim 30, wherein the operations further comprise, for each application downloaded to the first allocation of non-transitory memory:
deleting the application from the first allocation of non-transitory memory after a threshold period of time after the associated download start time; or
moving the application from the first allocation of non-transitory memory to second allocation of non-transitory memory in communication with the data processing hardware.

32. The user device of claim 31, wherein the first allocation of non-transitory memory comprises temporary non-transitory memory and the second allocation of non-transitory memory comprise permanent non-transitory memory.

33. A method comprising:
receiving, at data processing hardware, user device information of a user device in communication with the data processing hardware;
executing, by the data processing hardware, a search of a non-transitory data store in communication with the data processing hardware using a search criteria;
receiving, at the data processing hardware, application state records from the non-transitory data store in response to the executed search, each application state record comprising:
an application access mechanism having a reference to a corresponding application executable on the user device and indicating an operation for downloading and installing the corresponding application on the user device; and
application information describing application parameters associated with the corresponding application;
identifying one or more applications based on the user device information and the application parameters for download to the user device; and
sending search results from the data processing hardware to the user device, the search results comprising an application access mechanism for each identified application.

34. The method of claim 33, further comprising:
receiving, at the data processing hardware, user selectable parameters; and
identifying the one or more applications further includes identifying the one or more applications based on the user device information, the application parameters, and the user selectable parameters.

35. The method of claim 34, wherein the user selectable parameters include one or more of an application size, a user device connection to a network, an application category, an application developer, or an application user review.

36. The method of claim 33, wherein each application access mechanism of the search results includes a trigger instructing the user device to automatically download the corresponding application on the user device.

37. The method of claim 33, further comprising:
receiving, at the data processing hardware, the search criteria from the user device; or
determining the search criteria based on one or more application parameters.
